(19) United States
(12) Patent Application Publication
(10) Pub. No.: US 2006/0147773 A1
(43) Pub. Date: Jul. 6, 2006

(54) Heat and humidity exchanger

(76) Inventors: Jeremy D. Steinshnider, Bryan, TX (US); Craig C. Andrews, College, TX (US); Jeffrey S. Parkey, College Station, TX (US)

Correspondence Address: STREETS & STEELE, 13831 NORTHWEST FREEWAY, SUITE 355, HOUSTON, TX, 77040, US

(21) Appl. No.: 11/030,600

(22) Filed: Jan. 6, 2005

(51) Int. Cl. H01M 8/04; F24F 3/14

(52) U.S. Cl. 429/26; 236/44 C

(57) ABSTRACT

A heat and humidity exchanger stack formed by stacking at least one reactant gas source half-cell and at least one reactant gas exhaust half-cell, with each half-cell comprising a porous flowfield, wherein each pair of adjacent half-cells of the stacked heat and humidity exchanger are separated by a member selected from a water permeable/heat conducting member, a water impermeable/heat conducting member, or a water impermeable/heat insulating member and wherein at least one of the members is a water permeable/heat conducting member separating a reactant gas supply half-cell from an adjacent reactant gas exhaust half-cell. The stack may further comprise at least one thermal management fluid cell and/or a heat sink cell separated from the adjacent half-cells in the stack with one of the heat conducting or heat insulating members.

### BACKGROUND OF THE INVENTION

1. Field of the Invention

This invention relates to humidification of reactant gases used in electrochemical cells.

2. Description of the Related Art

An inherent limitation of current polymer electrolytes used in PEM fuel cells is that the membrane must be hydrated in order to conduct protons. Thus, the level of proton conductivity is largely dependent on the hydration level of the membrane. Despite the production of water at the cathode, back diffusion of water to the anode is often insufficient to overcome electroosmotic transport of water toward the cathode and maintain acceptable membrane hydration levels. One method of increasing hydration of the membrane includes raising the relative humidity of inlet reactant gases. By maintaining proper membrane hydration levels, the efficiency and performance of PEM fuel cells can be greatly enhanced.

The temperature of a PEM fuel cell, typically operating in a temperature range of 60-90° C., also affects the efficiency and performance of PEM fuel cells. In order to keep the PEM fuel cell within this temperature range and maintain performance, the fuel cell system requires some method of cooling. For example, cooling can be accomplished by using a heat exchange fluid, such as air or a liquid. Often water is chosen for the coolant in liquid cooled systems. While the fuel cell must be cooled, it may also be beneficial to heat the incoming reactant gases since water vapor partial pressure increases with temperature. Accordingly, heating the reactant gas to the operating temperature of the fuel cell allows a high level of humidity in the reactant gas while avoiding condensation of the water vapor when the gas enters the fuel cell. Controlling the humidity and temperature of the reactant gas supplied to the fuel cell improves performance of the cell.

Two convenient sources of water and heat exist for humidification in a typical PEM fuel cell system. One source is the water produced when oxygen combines with protons and electrons at the cathode. The oxidant gas exhaust, typically air or oxygen, carries this water in both liquid and vapor form while also absorbing some of the heat generated in the fuel cell. If the fuel cell is water cooled, then the hot exit coolant can also be a source for humidification and heating. Air-cooled stacks would be limited to using the oxidant exhaust. These are the most economical sources of heat and humidity since they are recovered byproducts of normal fuel cell operation and they reduce or eliminate the parasitic use of power.

### SUMMARY OF THE INVENTION

The present invention provides a heat and humidity exchanger comprising a reactant gas supply half-cell and a reactant gas exhaust half-cell, each having a porous flowfield, and each separated by a water permeable membrane. The exchanger may further include a thermal management fluid cell in fluid communication with a thermal management fluid source and a heat conducting separator disposed between the thermal management fluid cell and the reactant gas supply half-cell or the reactant gas exhaust half-cell. Optionally, the thermal management fluid cell may also comprise a porous thermal management fluid flowfield. The thermal management fluid source may be a cooling fluid source or a heating fluid source. For example, the thermal management fluid may be from the source of the cooling water supply to a fuel cell or the source may be the exhaust cooling water flowing from the fuel cell. Other sources of the thermal management fluid source are suitable for a given application as known to those having ordinary skill in the art.

In a preferred embodiment of the present invention, the exchanger may further include a second reactant gas supply half-cell in fluid communication with the reactant gas supply port of the fuel cell and a second heat conducting separator disposed between the thermal management fluid cell and the second reactant gas supply half-cell. Optionally, the thermal management fluid cell may further comprise a porous thermal management fluid flowfield, which is preferred if the second heat conducting separator is water permeable.

A preferred embodiment further includes a second reactant exhaust supply half-cell in fluid communication with the reactant gas exhaust port of the fuel cell and a water permeable membrane separating the second reactant gas supply half-cell and the second reactant gas exhaust half-cell. A stack of cells may be formed using combinations of half-cells and heat transfer fluid cells, each separated from those adjacent with a separator.

The flowfields of the half-cells and/or the heat transfer fluid cell are preferably each inset into frames. Preferably, the flowfields are metal foam but may be any other suitable material known to those having ordinary skill in the art including, for example, polymers, carbon composites, ceramics, metals or combinations thereof. The porous material may be formed from mesh, expanded material, spun web, open cell foams or combinations thereof. Optionally, one or more of the flowfields may comprise a hydrophobic coating or a hydrophilic coating.

In a preferred embodiment, ledges secure the flowfields into the frames. The ledges are adjacent to at least one side of each of the flowfields and the ledges may be integral to the frames, provided as a separate component or combinations thereof.

Optionally, one or more of the half-cells may further comprise a porous insert disposed between the supply flowfield and the water permeable membrane. The porous insert may be a polymer mesh and may be hydrophilic or hydrophobic as desired for a particular application. The porous insert should have a surface that cannot puncture or cut the water permeable membrane.

In a preferred embodiment, the exchanger may further comprise a heat sink cell having a phase change material sealed between two heat conducting separators, wherein one of the separators is disposed adjacent to the reactant gas supply half-cell or the reactant gas exhaust half-cell. The phase change material is preferably a material that changes phases from a solid to a liquid between about 1° C. and about 80° C. and may be selected from, for example, paraffin wax, molten salts, molten metal, alloys of molten metal, solder or combinations thereof.

In a preferred embodiment, the heat and humidity exchanger stack may be formed by stacking at least one reactant gas source half-cell and at least one reactant gas exhaust half-cell, each half-cell comprising a porous flowfield, wherein each pair of adjacent half-cells of the stacked heat and humidity exchanger are separated by a member selected from a water permeable/heat conducting member, a water impermeable/heat conducting member, or a water impermeable/heat insulating member and wherein at least one of the members is a water permeable/heat conducting member separating a reactant gas supply half-cell from an adjacent reactant gas exhaust half-cell.

The stack may further comprise at least one thermal management fluid cell in fluid communication with a thermal management fluid source, as described above, and one of the heat conducting members disposed between the thermal management fluid cell and the reactant gas supply half-cell or the reactant gas exhaust half-cell. Optionally, the thermal management fluid cell may comprise a porous thermal management fluid flowfield.

The stack may further comprise at least one heat sink cell comprising a phase change material sealed between two of the heat conducting members, wherein each of the heat sink cells is adjacent to the reactant gas supply half-cell, the reactant gas exhaust half-cell, the thermal management fluid cell or combinations thereof. The phase change material preferably changes phases from a solid to a liquid between about 1° C. and about 80° C. Examples of suitable phase change materials include paraffin wax, molten salts, alloys of molten metals, solders or combinations thereof. A ratio of the heat sink cells to the half-cells may preferably range between about 1:1 and about 1:8.

In a preferred embodiment, each half-cell is disposed adjacent to a half-cell of a different type with the porous flowfields inset into frames. The flowfields are preferably held in the frames by ledges adjacent to one side of each of the flowfields for securing the flowfields in the frames, wherein the ledges are integral to the frames, provided as a separate component, or combinations thereof.

The foregoing and other objects, features and advantages of the invention will be apparent from the following more particular description of a preferred embodiment of the invention, as illustrated in the accompanying drawings wherein like reference numbers represent like parts of the invention.

### BRIEF DESCRIPTION OF THE DRAWINGS

FIG. 1 is a schematic diagram of a reactant gas supply humidifier using reactant gas exhaust as a source of heat and humidity.

FIGS. 2A and 2B are schematic diagrams illustrating two arrangements of a reactant gas supply humidifier using reactant gas exhaust and cooling fluid exhaust as sources of heat and humidity.

FIG. 3 is a schematic diagram of a humidifier cell formed from two half-cells and a membrane.

FIG. 4 is an exploded view of one embodiment of a half cell in accordance with the present invention.

FIG. 5 is a face view of a single side frame with a ledge and inset member used in forming the half-cells of FIG. 3.

FIG. 6 is a process diagram of a humidifier using the oxidant exhaust from a fuel cell to heat and humidify the oxidant supply to the fuel cell.

FIG. 7 is a process diagram of a humidifier using the oxidant exhaust from a fuel cell to provide heat and humidity to the oxidant supply to the fuel cell, but also using a cooling fluid exhaust from the fuel cell to further heat the oxidant supply.

FIG. 8 is a process diagram of a humidifier using the oxidant exhaust from a fuel cell to provide heat and humidity to the oxidant supply to the fuel cell, and a cooling fluid exhaust from the fuel cell to further heat the oxidant supply and lower the relative humidity of the oxidant supply.

### DETAILED DESCRIPTION OF PREFERRED EMBODIMENTS

The present invention relates to a humidifier in communication with an electrochemical cell system that uses product water and/or coolant fluid from the electrochemical cell cooling fluid system to adjust the humidity and temperature of the cell inlet reactant gases. In a preferred embodiment, the electrochemical cell is a fuel cell wherein the humidifier utilizes a water permeable membrane to transfer water from the cathode exhaust containing product water, the cooling fluid exhaust, the cooling fluid supply or combinations thereof. The fuel cell inlet gas stream, such as the oxidant gas stream (typically oxygen or air), enters the humidifier and passes over one side of the water permeable membrane before entering the fuel cell. On the other side of the membrane, a hot, water-rich fluid such as flowing from the air exhaust and/or cooling water exhaust of a water cooled fuel cell, establishes a humidity or moisture gradient, temperature gradient, and/or pressure gradient across the membrane so that heat and water are transferred from one or both of the fuel cell exhaust streams into an inlet gas.

One embodiment of the humidifier uses a plate and frame construction including a water-permeable membrane sandwiched between an inlet reactant gas flowfield and outlet exhaust flowfield, such as the oxidant inlet steam and the exhaust stream of a fuel cell. A single humidifier “cell” is built from two subassemblies, henceforth called half-cells, that are separated by a membrane or other separator. Placing two half-cells in series makes one complete cell. Typically, a plurality of humidifier cells will be included in a humidifier “stack.”

Another embodiment of the humidifier includes one or more thermal management fluid cells disposed adjacent to one or more half-cells, typically a humidifier half-cell cell through which the inlet reactant gas flows. A thermal management fluid cell receives a heat transfer fluid for transferring heat to or from the inlet reactant gas stream. Typically, this embodiment is applicable to water cooled fuel cells but is not so limited. In a water cooled fuel cell application, a thermal management fluid cell receives the heated cooling water exhaust flowing from the cooling fluid channels of the fuel cell. The heated cooling water exhaust stream is used for heating the inlet reactant gas stream flowing through an adjacent cell. Any number of thermal management fluid cells may be used in a humidifier stack. Preferably, but without limiting the invention, the ratio of thermal management fluid cells to humidifier cells may range between about 1 to 1 and about 1 to 4.

Yet another embodiment includes one or more heat sink cells disposed adjacent to one or more humidifier half-cells. A heat sink cell includes a thermally conducting component that is in thermal communication with the fuel cell to transfer heat energy from the fuel cell to the humidifier. In one preferred embodiment, a phase change material is sealed within a heat sink cell and is useful for storing heat transferred from the electrochemical cell stack to provide, for example, a quicker warm-up time for the electrochemical cell stack during intermittent start/stop operations. The heat sink cell may be used, for example, to keep the membrane from freezing in cold climates. Any number of heat sink cells may be used in a humidifier stack. Preferably, but without limiting the invention, the ratio of heat sink cells to humidifier cells may range between about 1 to 1 and about 1 to 4.

The components of the humidifier may be made from various materials known to have material properties consistent with the temperature and other conditions that exist in the humidifier. For example, structural components of the humidifier may include polymers, carbon, ceramics, or metal such as stainless steel, titanium, nickel, nickel-plated aluminum, nickel plated magnesium, tin-plated nickel, tin-plated aluminum or combinations thereof. Light or easily oxidized metal components, such as those made from aluminum, magnesium, or alloys containing aluminum or magnesium are preferably coated with a layer of a corrosion resistant transition metal or other corrosion resistant coating. Suitable corrosion resistant transition metals include, but are not limited to, cobalt, copper, silver, nickel, gold or combinations thereof. Nickel is the most commonly used metal for the corrosion resistant layer.

In one preferred embodiment, a humidifier half-cell includes a flowfield and a frame that has channels providing communication between the flowfield and a fluid source. The flowfield is preferably a porous media and is inset in the frame to provide support for the membrane that separates the half-cells. Alternatively, the flowfield may be an empty volume through which the reactant gas supply, the reactant gas exhaust or the heat transfer fluid flows but the separator between the half-cell must be of a material that does not need support of the flowfield. A preferred flowfield includes open cell metal foam since the metal foam provides excellent heat transfer and fluid distribution with low pressure drop. Additionally, the rigidity of the metal foam provides support for the membrane disposed against the flowfield and assists in proper sealing of the polymer frame components that overlap the flowfield, namely the ledge. Porous polymers, carbon composites, and ceramics may also be used as flowfields. Suitable porous materials include, but are not limited to, mesh, expanded material, spun web, and open cell foams.

The humidifier flowfields may also include various coatings and surface modifications in order to modify some of the material properties of the flowfield. For example, metal foam may be coated with an oxide layer or be plated with a combination of other metals in order to impart better corrosion resistance or a hydrophilic coating may be applied in order to increase the wettability of the material. A flowfield with high wettability provides improved transfer of water from the exhaust gas stream to the membrane. Optionally, the flowfield may include one or more metal components and one or more polymer components. Another embodiment of the flowfield may include the use of hydrophobic coatings such as Teflon®, gold, or other hydrophobic materials. These hydrophobic coatings can act to trap liquid water close to the membrane and allow the reactant gases to take water in vapor form rather than as droplets. Any of the flowfields may be made hydrophobic or hydrophilic as desired for a given application.

An individual humidifier flowfield is preferably held in place in a frame by the use of a ledge associated with the frame. The ledge is preferably a thin layer and the ledge may also function to enclose individual reactant gas ports between the flowfield and a manifold and may provide a sealing surface for the membrane. The ledge may be integral to the frame, provided as a separate component, or a combination thereof. If the ledge is a separate component, the ledge is preferably adhered and sealed to the frame using an adhesive, such as an epoxy, pressure sensitive adhesive, or thermoplastic adhesive. The humidifier flowfield is preferably sandwiched between a pair of ledges to firmly hold the flowfield within the frame.

Optionally, a thin insert of porous media, such as a polymer mesh, may be held in place by the ledge to cover the sharp edges of the flowfield. Inserting the porous media insert to cover the sharp edges of the flowfield is advantageous because the thin polymer membranes are typically sensitive to punctures or other damage from contact with the rough surface of metal foam. Alternatively, the porous media inset useful for protecting the thin polymer membranes may include a hydrophilic or water-absorbent layer, such as carbon cloth, polymer diapers, or other material. These materials are useful for wicking water from the flowfield to the membrane, thereby increasing water transfer efficiency. Other inserts may include, but are not limited to polymer screens, expanded polymers, metal screens, metal mesh, and expanded metals. The metal inserts can be oxidized or plated with other metals to provide corrosion resistance. In a humidifier, electrical conductivity across the cell is not an issue for consideration as it is in electrochemical cells. Therefore, the materials for a humidifier of the present invention may be selected without regard to their electrical conductance. Furthermore, like the flowfields, the inserts may be made hydrophobic or hydrophilic, as desired for a given application, by choosing materials and/or coatings having the desired properties as known to those having ordinary skill in the art.

In further embodiments, instead of separating and fluidically isolating two half cells with a membrane, the membrane may be replaced with a separator useful for separating and fluidically isolating two half cells. The separator may be metal, carbon composite, ceramic, or polymer. The separator preferably has high heat transfer properties, such as provided by a metal. For example, a membrane is used to fluidically isolate the oxidant exhaust gas half cell from the inlet reactant gas half cell when the oxidant exhaust gas from a fuel cell is used as the humidity source. A separator is used to fluidically isolate the cooling fluid exhaust half cell from the inlet reactant gas half cell when the cooling fluid exhaust from the fuel cell is used as a heat source.

A preferred water permeable membrane useful in the humidifier of the present invention is a thin Nafion® (a trademark of DuPont of Wilmington, Del.) perfluorinated sulphonic acid polymer membrane, most preferably having a thickness between 1 and 10 mils. Other useful water permeable membranes include Kynar-based proton exchange membranes (available from Atofina), high temperature membranes like those developed by Sony, methanol crossover resistant membranes like those developed by PolyFuel, and composite membranes. Other types of water permeable materials include, without limitation, the use of perforated metals, plastics, carbon composites, or ceramics with pore sizes small enough to allow capillary action to pass water across the membrane.

Multiple cells may be created by stacking half-cells in series so that the flow channels created by the frame are partitioned to communicate each flowfield with a separate set of manifold ports. Note that in this type of assembly all half-cells share two membranes, separators or combinations thereof except for the first and last half-cell. The first and last half-cells are typically capped with an endplate. Separators may optionally replace membranes in the cell stack only when heat transfer, and not humidification, is to occur between two half cells. Optionally, separators may be used between pairs of half cells to isolate one full cell from other cells. The membrane may be cut to a dimension that just overlaps the inside edge of the ledge or the membrane may be cut to the same dimensions as the ledge (i.e., full overlap). As with bonding a ledge to a frame, the membrane may be sealed between half-cells using gaskets, o-rings, or an adhesive, such as an epoxy, pressure sensitive adhesive, or a thermoplastic adhesive. Multiple cells or half-cells may be bonded together using bonding techniques well known to those having ordinary skill in the art such as, for example, adhesives, brazing and welding. Alternatively or additionally, the multiple cells may be held together with tie bars as known to those having ordinary skill in the art, especially in high pressure applications.

For embodiments of the present humidifiers that utilize both exhaust oxidant air and the exhaust from a fuel cell cooling fluid loop, several modifications to the stack assembly are required. First, the humidifiers must have cooling cells that are built in a manner similar to the humidifying half-cells, but with a separator replacing the membrane to fluidically isolate the half cells from each other. Second, a third set of manifold ports are necessary to maintain separation of the coolant fluid from the reactant gas stream and the reactant exhaust stream and to circulate the heated cooling fluid exhaust stream through the thermal management cell. Preferably, the thermal management cell is positioned between two reactant flowfields in order to provide the most efficient transfer of heat from the cooling fluid to the incoming reactant gas. This would give the stack an ABCBA assembly order where A is the exhaust flowfield (source of both heat and humidity), B is the reactant flowfield (the gas to be heated and humidified), and C is the thermal management cell (another source of heat). However, an example of a less efficient but equally feasible assembly order could be ABCABC.

In an embodiment that includes a heat sink cell, the heat sink cell holds phase change materials. Phase change materials remain solid as they absorb heat until a critical temperature is reached where the materials liquefy as they continue to absorb heat. When the heat input is stopped, the phase change materials cool as they release the heat that was absorbed and again turn into a solid. Since the latent heat of fusion of the phase change materials is higher than the heat capacity of other materials, the phase change materials provide a useful thermal storage system. In one preferred embodiment, the humidifier has one or more heat sink cells in the stack that are completely enclosed and not in communication with any of the fluid manifolds that circulate gases or liquids through the flowfields of the other half cells. The sealed heat sink cells are filled with phase change material and act as a thermal sink in thermal communication with the half cells through a separator. Examples of phase change materials include, but are not limited to, microencapsulated paraffin wax, molten salts, molten metals and their alloys and solders and combinations thereof. Preferably, suitable phase change materials are those that undergo a phase change from a solid to a liquid between about 1° C. and about 80° C. or more preferably, between about 25° C. and about 70° C.

The thickness of the individual half-cells and the thickness of the thermal management fluid cells and the heat sink cells may be of any desired thickness and, without limiting the invention, may range preferably between about 5 to 100 mils, more preferably between about 10 and 70 mils and most preferably between about 15 and 50 mils. Of course, each type of cell or half cell may have different thicknesses and each type of cell within a stack may have different thicknesses. The shapes of the cells may be any shape suitable for the humidifier design, including square, rectangular, circular, oval, and so forth.

Once a stack of the various humidifier cells is configured, the stack is preferably sealed to endplates that also provide the compression necessary for sealing if gaskets or o-rings are used with tie rods. Manifolds providing fluid transfer to and from the stack may be located external or internal to the endplates and may be arranged to provide cross-flow, concurrent flow, countercurrent flow or z-flow of the various fluids. Preferably, the endplates are structurally strong and corrosion resistant.

Optionally, the humidifier may include a control system that allows a portion, all or none of either a dry reactant gas, a wet gas, or even a thermal management fluid stream to bypass the humidifier. Accordingly, the relative humidity and temperature of a gas supplied to an electrochemical cell can be varied.

In yet another embodiment, individual cells selected from among the cell types described above may be arranged to provide a set of desired results, primarily control of the temperature and humidity of a reactant gas stream being provided to an electrochemical cell or cell stack, such as a fuel cell or fuel cell stack. One preferred embodiment includes arranging the cells so that the reactant gas flows through a series of cells to achieve the desired temperature and humidity. For example, the reactant gas may first flow through a first reactant gas cell disposed between a thermal management fluid cell (having a separator that transfers heat to the reactant gas) and an oxidant exhaust gas cell (having a water transfer membrane that conveys moisture and heat into the reactant gas) and then flow through a second reactant gas cell that is disposed between another thermal management fluid cell (transferring heat into the reactant gas) and a phase change fluid cell (transferring heat into the reactant gas). In this example, it may be possible to saturate the reactant gas with water vapor at a first outlet temperature from the first reactant gas cell and then raise the temperature of the reactant gas further at the outlet of the second reactant gas cell in order to reach a target temperature and a target relative humidity for use in the fuel cell. Temperature sensors and humidity sensors may be disposed between selected cells in a stack and at the outlet of the stack as known to those having ordinary skill in the art. The sensors may provide input to the controller that may then operate valves to bypass one or all of selected streams around the stack to control the humidity and temperature of a stream to a desired setpoint.

In the operation of a fuel cell, as well as other electrochemical cells, it is preferable to prevent water vapor from condensing from the reactant gas upon introducing the humidified reactant gas into the fuel cell. Control of the reactant gas temperature and relative humidity can prevent condensation from occurring. Typically, condensation is prevented when the humidified reactant gas stream is provided at the fuel cell operating temperature with a relative humidity less than 100%, more preferably a relative humidity less than 90%. Optionally, any entrained water droplets may be eliminated by passing the humidified reactant gas outlet through a water knockout pot, vessel or coalescer prior to introducing the humidified reactant gas into the fuel cell.

In another embodiment of the present invention, electrical heaters may be used to heat the stack while the stack is not in operation. Keeping the stack above freezing during intermittent operation in, for example, winter conditions may maintain the membranes above freezing. An electrical current may be run through the separators or through metal flowfields to heat them and transfer heat through the stack. Preferably, the separators of the heat sink cells are heated intermittently to change the phase change material from a solid back to a liquid. The electrical current may be controlled by a timer, set to turn the current on at a set time to warm the stack before an anticipated start time, or may be switched on by a temperature measurement device within the humidifier stack to maintain a temperature within the stack above a setpoint, or combinations thereof.

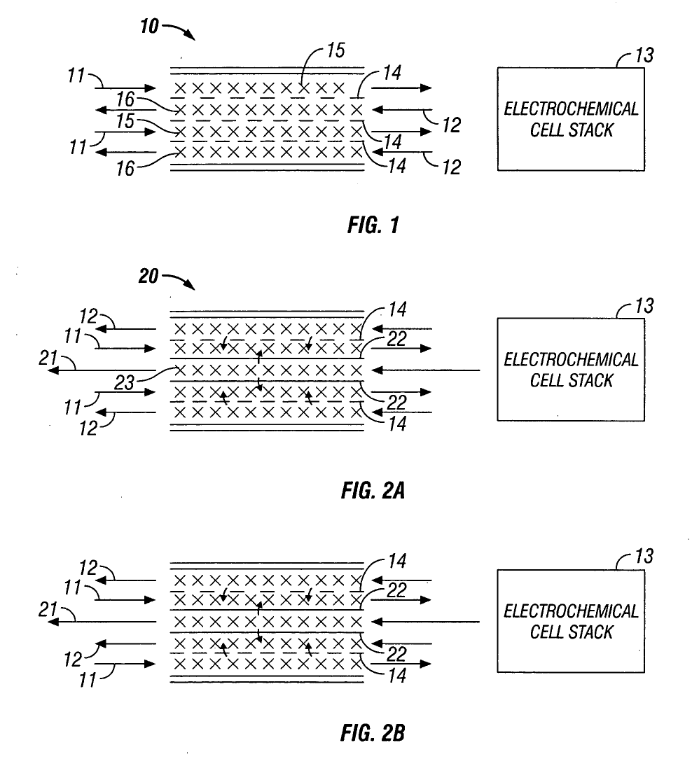

FIG. 1 is a schematic diagram of a reactant gas feed humidifier using reactant gas exhaust as a source of heat and humidity. In the embodiment of a reactant gas feed humidifier 10 illustrated in FIG. 1, a reactant gas feed 11 to an electrochemical cell 13 is humidified and heated by a hot, water-containing exiting stream 12 from the electrochemical cell 13. The reactant gas feed 11 is humidified by the water that passes through the membrane 14 from the exiting stream 12. The reactant gas feed 11 is heated by the heat transferred across the membrane 14 from the exiting stream 12. The exiting stream 12 flows through a porous flowfield 16 and the reactant gas feed flows through a porous flowfield 15. Each of the streams 11, 12 flow through separate half cells that are separated from each other by the membranes 14.

FIGS. 2A and 2B are schematic diagrams illustrating two arrangements of a reactant gas feed humidifier using reactant gas exhaust and cooling fluid exhaust as sources of heat and humidity. In the embodiment of a reactant gas feed humidifier 20 illustrated in FIG. 2A, the reactant gas feed 11 is humidified by the water that passes through the membrane 14 from the exiting stream 12 and is further heated by the warm cooling fluid stream 21 exiting the electrochemical cell stack 13. Heat may also transfer from the exiting stream 12 to the reactant gas feed 11 through the membranes 14. The warm cooling fluid stream 21 is separated from the reactant gas feed stream 11 by separators 22, which are preferably made of metal to maximize the heat transfer rate. A porous cooling fluid flowfield 23 is provided between the separators 22.

The embodiment of a reactant gas feed humidifier 20 illustrated in FIG. 2B may be less efficient than the embodiment shown in FIG. 2A because the heat transfer half cell through which the warm cooling fluid 21 flows is disposed between the half cell for the reactant gas feed 11 and the half cell for the exiting steam 12. Though this arrangement may be preferable in some applications, the warm cooling fluid 12 can transfer heat to the reactant gas feed 11 only through one of the separators 22 that define the heat transfer cell through which the warm cooling fluid stream 21 flows. The other separator 22, which separates the cooling fluid stream 21 from the exiting stream 12, provides a heat transfer surface area for transferring heat either to or from the exiting gas stream 12 depending on which of the two streams are hotter.

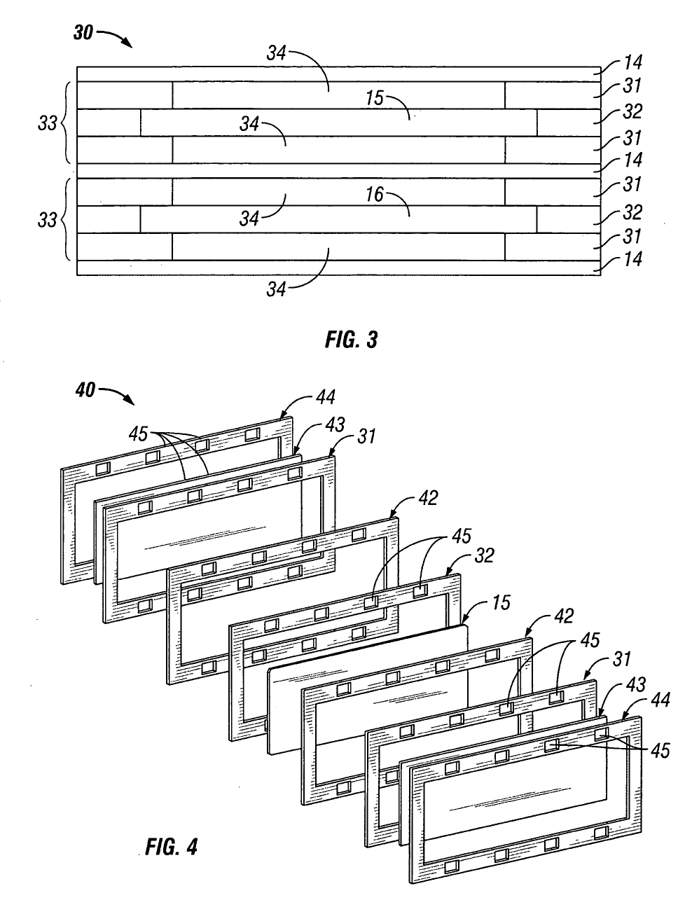

FIG. 3 is a schematic diagram of a humidifier cell formed from two half-cells and a membrane. The humidifier cell 30 is formed from two half cells 33. A half cell 33 includes a frame 32 that is disposed between two ledges 31. The half cells 33 are separated by a membrane 14. The ledges 31 hold the flowfields 15, 16 in the frame 32. An optional porous mesh insert 34 protects the membranes 14 from damage by the porous flowfields 15, 16. One or both of the membranes 14 disposed on each end of the cell may be replaced with a separator, if one of the half cells 33 is adjacent to a heat transfer cell, or with an endplate, if the cell stack ends at the half cell 33.

FIG. 4 is an exploded view of one embodiment of a half cell in accordance with the present invention. The illustrated embodiment of a half cell 40 includes a frame 32 for supporting a porous flowfield 15. The frame 32 and the porous flowfield 15 are disposed between two ledges 31 that hold the porous flowfield 15 in place. In the illustrated embodiment of the half cell 40, the ledges 31 are sealed against the frame 32 with an adhesive tape 42 cut to conform to the shape of the frame 32. Porous mesh inserts 43 are disposed on opposite sides of the porous flowfield 15 to prevent the flowfield 15 from puncturing or tearing the membrane 14, shown in FIG. 3. The mesh inserts 43 are held in place by adhesive tape 44 that is cut to conform to the shape of the ledges 31. Manifolds 45 are cut through the components of the half cell 40 to provide circulation of reactants, coolants and other fluids through a humidifier cell stack as known to those having ordinary skill in the art.

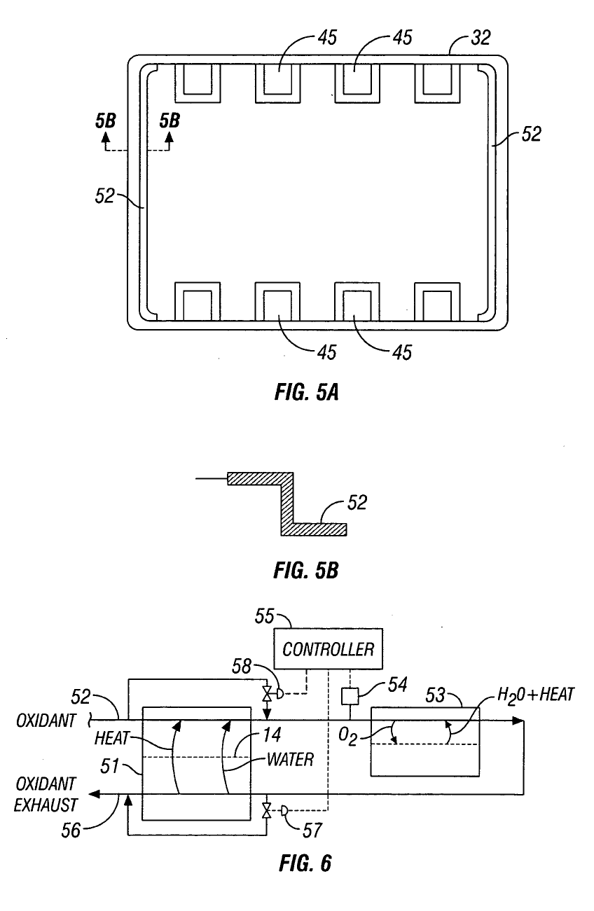

FIGS. 5A and 5B are top and cross sectional views of a frame having a ledge that is integral to the frame and is useful for holding a flowfield in place. The illustrated frame 32 may be used for holding a flowfield in place with a ledge 52 that is integral to the frame 32. A first side of a flowfield 15, as shown in FIG. 4, may be held by the integral ledge 52 while a separate component ledge 31, as shown in FIG. 4, holds the second side of the flowfield 15. The integral ledge 52 may extend around just a portion of the frame 32 perimeter as shown, or may extend around the frame perimeter to any extent adequate to support the flowfield 15.

FIG. 6 is a process diagram of a humidifier using the oxidant exhaust from a fuel cell to heat and humidify the oxidant supply to the fuel cell. A humidifier stack 51 comprising half cells 33, as shown in FIG. 3, humidifies and heats an oxidant stream 52 entering a fuel cell 53. Sensors 54 measure the humidity and temperature of the oxidant stream 52 entering the fuel cell 53 and send these measurements to a controller 55. The controller 55, which can be a digital control system or an analogue control system, controls the volumes of both the oxidant stream 52 and the exhaust stream 56 flowing through the humidifier stack 51 by adjusting individual bypass valves 57, 58 on each of these streams. By adjusting these bypass valves 57, 58, the temperature and humidity of the oxidant stream 52 can be controlled.

As the oxidant stream 52 flows through the fuel cell stack 53, heat and water are released and carried from the fuel cell stack 53 by the exhaust oxidant stream 56 as known by those having ordinary skill in the art. The heat and moisture are exchanged across the membranes 14 of the humidifier stack 51 to heat and humidify the oxidant stream 52 as desired.

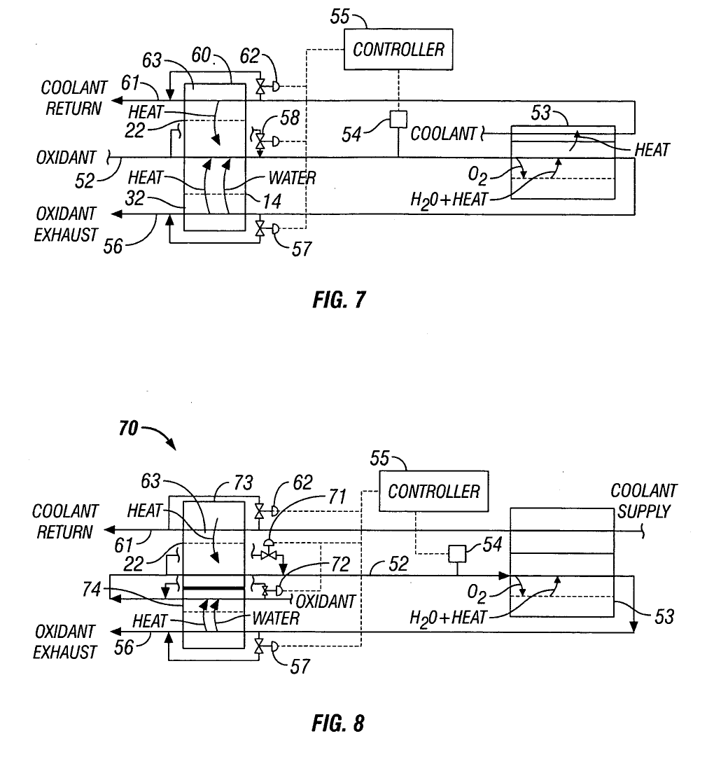

FIG. 7 is a process diagram of a humidifier using the oxidant exhaust from a fuel cell to heat and humidify the oxidant supply to the fuel cell, but also using a cooling fluid exhaust from the fuel cell to further heat the oxidant supply in accordance with the present invention. A humidifier stack comprising half cells 33, as shown in FIG. 3, and heat transfer cells 63 disposed between at least a portion of the half cells 33, humidifies and heats an oxidant stream 52 entering a fuel cell 53. The heat transfer cells 63 include separators 22 that seal the coolant return 61 from the oxidant stream 52 and provide the heat transfer surface between the two streams 61, 52.

Sensors 54 measure the humidity and temperature of the oxidant stream 52 entering the fuel cell 53 and send these measurements to a controller 55. The controller 55 controls the volumes of both the oxidant stream 52, the exhaust stream 56 and the coolant return stream 61 by adjusting individual bypass valves 57, 58, 62 on each of these streams. By adjusting these bypass valves, 57, 58, 62, the temperature and humidity of the oxidant stream 52 can be controlled.

The heat and water carried from the fuel cell stack 53 by the oxidant exhaust stream 56 exchange across the membranes 14 with the oxidant stream 52 to humidify and heat the oxidant stream 52 as desired. Similarly, the heat carried from the fuel cell stack 53 by the coolant return stream 61 exchanges across the separators 22 with the oxidant stream 52 to heat the oxidant stream as desired.

FIG. 8 is a process diagram of a humidifier using the oxidant exhaust from a fuel cell to heat and humidify the oxidant supply to the fuel cell, and a cooling fluid exhaust from the fuel cell to further heat the oxidant supply and lower the relative humidity of the oxidant supply. The humidifier 70 of the illustrated embodiment includes a stack 74 of half cells 33, as shown in FIG. 3, and a separate stack 73 of heat transfer cells 63 that humidifies and heats an oxidant stream 52 entering a fuel cell 53. The heat transfer cells 63 include separators 22 that seal the coolant return 61 from the oxidant stream 52 and provide the heat transfer surface between the two streams 61, 52.

The controller 55 controls the volumes of the oxidant stream 52 flowing through the stack 74 of the humidifying half cells, the oxidant stream 52 flowing through the stack 73 of heat transfer cells, the exhaust stream 56 and the coolant return stream 61 by adjusting individual bypass valves 57, 71, 72, 62 on each of these streams. By adjusting these bypass valves, 57, 71, 72, 62, the temperature and relative humidity of the oxidant stream 52 can be controlled.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A heat and humidity exchanger for a fuel cell, comprising:
a reactant gas supply half-cell comprising a porous supply flowfield in fluid communication between a reactant gas source and a reactant gas inlet port of the fuel cell;
a reactant gas exhaust half-cell comprising a porous exhaust flowfield in fluid communication with a reactant gas exhaust port of the fuel cell; and
a water permeable membrane separating the reactant gas supply half-cell and the reactant gas exhaust half-cell.

2. The exchanger of claim 1, further comprising:
a thermal management fluid cell in fluid communication with a thermal management fluid source; and
a heat conducting separator disposed between the thermal management fluid cell and the reactant gas supply half-cell or the reactant gas exhaust half-cell.

3. The exchanger of claim 2, wherein the thermal management fluid cell comprises a porous thermal management fluid flowfield.

4. The exchanger of claim 2, further comprising:
a second reactant gas supply half-cell in fluid communication with the reactant gas supply port of the fuel cell; and
a second heat conducting separator disposed between the thermal management fluid cell and the second reactant gas supply half-cell.

5. The exchanger of claim 4, wherein the second heat conducting separator is water permeable, the thermal management fluid cell further comprises a porous cooling fluid flowfield.

6. The exchanger of claim 5, further comprising:
a second reactant exhaust supply half-cell in fluid communication with the reactant gas exhaust port of the fuel cell; and
a water permeable membrane separating the second reactant gas supply half-cell and the second reactant gas exhaust half-cell.

7. The exchanger of claim 1, further comprising:
a second reactant exhaust supply half-cell in fluid communication with the reactant gas exhaust port of the fuel cell; and
a second heat conducting separator disposed between the thermal management fluid cell and the second reactant gas exhaust half-cell.

8. The exchanger of claim 7, wherein the second heat conducting separator is water permeable.

9. The exchanger of claim 2, wherein the heat conducting separator is water permeable.

10. The exchanger of claim 1, wherein the porous supply flowfield and the porous exhaust flowfield are each inset into frames.

11. The exchanger of claim 10, wherein the flowfields are metal foam.

12. The exchanger of claim 10, wherein the flowfields are selected from a porous material selected from polymers, carbon composites, ceramics, metals or combinations thereof.

13. The exchanger of claim 12, wherein the porous material is selected from mesh, expanded material, spun web, open cell foams or combinations thereof.

14. The exchanger of claim 1, wherein at least one of the flowfields comprises a hydrophobic coating.

15. The exchanger of claim 1, wherein at least one of the flowfields comprises a hydrophilic coating.

16. The exchanger of claim 1, further comprising:
frames surrounding each of the flowfields, and
ledges adjacent to one side of each of the flowfields for securing the flowfields in the frames, wherein the ledges are integral to the frames, provided as a separate component, or combinations thereof.

17. The exchanger of claim 1, wherein the reactant gas supply half-cell further comprises a porous insert disposed between the supply flowfield and the water permeable membrane.

18. The exchanger of claim 17, wherein the porous insert is a polymer mesh.

19. The exchanger of claim 17, wherein the porous insert is hydrophilic.

20. The exchanger of claim 17, wherein the porous insert has a surface that cannot puncture or cut the water permeable membrane.

21. The exchanger of claim 17, wherein the flowfield is metal foam.

22. The exchanger of claim 17, wherein the flowfield is selected from a porous material selected from polymers, carbon composites, ceramics, metals or combinations thereof.

23. The exchanger of claim 17, wherein the flowfield comprises a hydrophobic coating.

24. The exchanger of claim 17, further comprising:
a ledge adjacent to one side of the flowfield for securing the flowfield in the frame, wherein the ledge is integral to the frame, provided as a separate component, or combinations thereof.

25. The exchanger of claim 1, wherein the reactant gas exhaust half-cell further comprises a porous insert disposed between the flowfield and the water permeable membrane.

26. The exchanger of claim 25, wherein the porous insert is a polymer mesh.

27. The exchanger of claim 25, wherein the porous insert is hydrophilic.

28. The exchanger of claim 25, wherein the porous insert has a surface that cannot puncture or cut the water permeable membrane.

29. The exchanger of claim 25, wherein the flowfield is metal foam.

30. The exchanger of claim 25, wherein the flowfield is selected from a porous material selected from polymers, carbon composites, ceramics, metals or combinations thereof.

31. The exchanger of claim 25, wherein the flowfield comprises a hydrophilic coating.

32. The exchanger of claim 25, further comprising:
a ledge adjacent to one side of the flowfield for securing the flowfield in the frame, wherein the ledge is integral to the frame, provided as a separate component, or combinations thereof.

33. The exchanger of claim 1, further comprising:
a heat sink cell comprising a phase change material sealed between two heat conducting separators, wherein one of the separators is disposed adjacent to the reactant gas supply half-cell or the reactant gas exhaust half-cell.

34. The exchanger of claim 33, wherein the phase change material changes phases from a solid to a liquid between about 1° C. and about 80° C.

35. The exchanger of claim 33, wherein the phase change material is selected from paraffin wax, molten salts, molten metal, alloys of molten metal, solder or combinations thereof.

36. A heat and humidity exchanger stack for a fuel cell, comprising:
at least one reactant gas supply half-cell comprising a porous supply flowfield in fluid communication between a reactant gas source and a reactant gas inlet port of the fuel cell;
at least one reactant gas exhaust half-cell comprising a porous exhaust flowfield in fluid communication with a reactant gas exhaust port of the fuel cell, wherein each pair of adjacent half-cells of the stacked heat and humidity exchanger are separated by a member selected from a water permeable/heat conducting member, a water impermeable/heat conducting member, or a water impermeable/heat insulating member and wherein at least one of the members is a water permeable/heat conducting member separating a reactant gas supply half-cell from an adjacent reactant gas exhaust half-cell.

37. The stack of claim 36, further comprising:
at least one thermal management fluid cell in fluid communication with a thermal management fluid source; and
one of the heat conducting members disposed between the thermal management fluid cell and the reactant gas supply half-cell or the reactant gas exhaust half-cell.

38. The stack of claim 37, wherein the thermal management fluid cell comprises a porous thermal management fluid flowfield.

39. The stack of claim 37, wherein a ratio of the thermal management fluid cells to the half-cells is between about 1:1 and about 1:8.

40. The stack of claim 37, wherein the heat conducting member is water permeable.

41. The stack of claim 37, wherein at least one thermal management fluid cell is adjacent to one of the reactant gas exhaust half-cells and separated by the water impermeable/thermally insulating member.

42. The stack of claim 36, further comprising:
at least one heat sink cell comprising a phase change material sealed between two of the heat conducting members, wherein each of the heat sink cells is adjacent to the reactant gas supply half-cell, the reactant gas exhaust half-cell, the thermal management cell or combinations thereof.

43. The stack of claim 42, wherein the phase change material changes phases from a solid to a liquid between about 1° C. and about 80° C.

44. The stack of claim 43, wherein the phase change material is selected from paraffin wax, molten salts, alloys of molten metals, solders or combinations thereof.

45. The stack of claim 42, wherein a ratio of the heat sink cells to the half-cells is between about 1:1 and about 8.

46. The stack of claim 36, wherein each half-cell is disposed adjacent to a half-cell of a different type.

47. The stack of claim 36, wherein the porous flowfields are each inset into frames.

48. The stack of claim 47, wherein the flowfields are metal foam.

49. The stack of claim 47, wherein the flowfields are selected from a porous material selected from polymers, carbon composites, ceramics, metals or combinations thereof.

50. The stack of claim 49, wherein the porous material is selected from mesh, expanded material, spun web, open cell foams or combinations thereof.

51. The stack of claim 36, wherein at least one of the flowfields comprises a hydrophobic coating.

52. The stack of claim 36, wherein at least one of the flowfields comprises a hydrophilic coating.

53. The stack of claim 36, further comprising:
ledges adjacent to one side of each of the flowfields for securing the flowfields in the frames, wherein the ledges are integral to the frames, provided as a separate component, or combinations thereof.

54. The stack of claim 3367, wherein at least one of the half-cells further comprise a porous insert disposed between the flowfield and the member.

55. The stack of claim 54, wherein the porous insert is a polymer mesh.

56. The stack of claim 54, wherein the porous insert is hydrophilic.

57. The stack of claim 54, wherein the porous insert has a surface that cannot puncture or cut the water permeable membrane.

58. The stack of claim 36, further comprising:
a power source for providing an electrical current through one or more of the flow fields for heating the stack.

59. The stack of claim 42, further comprising:
a power source for providing an electrical current through one or more of the heat conducting members of at least one heat sink cell for heating the phase change material.

60. The stack of claim 36, further comprising:
a power source for providing an electrical current through one or more of the members for heating the stack.
